(19) United States
(12) Patent Application Publication
(10) Pub. No.: US 2004/0131129 A1
(43) Pub. Date: Jul. 8, 2004

(54) Method and apparatus for reducing the power consumption of the power amplifier used in a QAM modulator

(76) Inventors: Gerald Harron, Martensville (CA); Douglas Fast, Warman (CA); Surinder Kumar, Victoria (CA)

Correspondence Address: ADE & COMPANY, 1700-360 MAIN STREET, WINNIPEG, MB, R3C3Z3, CA

(21) Appl. No.: 10/671,879

(22) Filed: Sep. 29, 2003

Related U.S. Application Data
(60) Provisional application No. 60/414,393, filed on Sep. 30, 2002.

(51) Int. Cl. H04L 27/36

(52) U.S. Cl. 375/298

(57) ABSTRACT

The present inventions provide methods and systems for optimizing the power consumption of a power amplifier used to amplify a QAM modulated signal by dynamically adjusting its compression point. The compression point is adjusted based upon the instantaneous peak value of the base band QAM signal.

This application claims priority under 35 U.S.C.119 from U.S. Provisional Application Serial No. 60/414,393 filed Sep. 30, 2002.

### FIELD OF THE INVENTION

This invention relates generally to communication systems. The present invention relates more specifically to reducing the power consumption of the power amplifier used in a QAM modulation system.

### BACKGROUND OF THE INVENTION

In digital communication technology today, one of the more common methods of packing more data bits within an allocated bandwidth is performed using multilevel systems or M-ary techniques. Since digital transmission is notoriously wasteful of RF bandwidth, regulatory authorities usually require a minimum bit packing. One of the more common techniques combining both amplitude and phase modulation is known as M-ary quadrature amplitude modulation (QAM). QAM modulates two different signals into the same bandwidth. This is accomplished by creating a composite amplitude modulated signal using two carriers of the same frequency. The two carriers are distinguished by having a phase difference of 90 degrees. By convention, the cosine carrier is called the in-phase component and the sine carrier is the quadrature component.

One example of a prior art QAM modulator is described hereinafter in conjunction with the Figures.

A problem in the design of linear power amplifiers is the effect of the transmitted signal's peak-to-average ratio on performance. The operating point of the power amplifier is determined by the peak power in the driving signal. The peak-to-average power ratio for QAM is typically 10 dB or more. As the peak-to-average ratio (PAR) increases, the power amplifier back-off (or additional headroom required) in order to ensure minimal compression of the output signal increases proportionally. Too much compression of the output signal results in splatter. Splatter, which is signal energy that extends beyond the frequency band allocated to a signal, is highly undesirable because it interferes with communications on adjacent channels. Furthermore, when multiple signals are combined prior to amplification, the PAR of the sum is very often higher than that for the single channel. This requires amplifier back off greater than that already mentioned.

A number of techniques have been developed to lower the 1 dB compression point of the power amplifier, thereby reducing its power consumption. Many of these focus on reducing the peak to average ratio of the driving signal. Common techniques include

1 Power amplifier efficiency improvements, such as achieved with SiGe technology. This includes making the input vs output power curve more linear up to the 1 dB compression point.

2. Inearization of power amplifiers to correct for the linearity loss as the amplifier gets closer to compression. Numerous techniques are common such as feed forward linearization. (ex. Feed-Forward Amplifier, U.S. Pat. No. 6,392,483)

3. Coding techniques to reduce the peak to average ratio of the data content, by controlling the symbols. (Method and apparatus for power control in a transmitter, as shown in U.S. Pat. No. 6,298,094 issued October 2, 2001 by Dehner et al)

4. Baseband pre-distortion of high power nonlinearity (Direct QAM Modulator, as shown in U.S. Pat. No. 5,852,389 Issued December 22, 1998 by Kumar et al.)

5. Methods of peak to average reduction (as shown in U.S. Pat. No. 6,597,746 issued Jul. 22, 2003 by Amrany et al and U.S. Pat. No. 6,512,797 issued Jan. 28, 2003 by Tellado et al and U.S. Pat. No. 5,381,449 issued Jan. 10, 1995 by Jasper et al) exist in various forms, and increase average power a given amplifier can support. Reduction of the peak power allows reduction of the compression necessary to handle the peak power. One method of reducing PAR is hard clipping, which reduces each signal value exceeding a clip threshold to a predetermined magnitude, often the threshold magnitude. Hard-clipping causes significant splatter due to the abrupt nature of its operation. Another method of reducing PAR is a “soft” algorithm that applies the desired signal to a non-linear device that limits signal peaks. A significant proportion of the input samples must be altered, causing significant energy to be splattered into adjacent channels.

Even with the reduction of the PAR, the power amplifier is still operated inefficiently. This is because it is operated at a constant compression point. This means that the amplifier is very inefficient when amplifying small signals.

6. Power control of an amplifier has been commonly used to increase the efficiency of an amplifier, but these are limited to using the amplifier itself to produce the modulation. (Ex High-efficiency modulation RF amplifier, as shown in U.S. Pat. No. 6,377,784 issued April 23, 2002 by McCune)

7. The invention as shown in U.S. Pat. No. 6,137,841 issued Oct. 24, 2000 by Velez et al (Signal power adjustment for QAM communication systems) recognized the need for the linear amplification of a QAM signal, and a provides a method of adjusting the QAM power (not the amplifier compression) to maximize the use of a given amplifier for different QAM levels. It does not however consider dynamic adjustment of the compression of the power amplifier to maximize its efficiency.

What is desired is a method of dynamically adjusting the compression of a linear power amplifier in order to reduce its power consumption to an optimum value. It should allow the amplifier to operate with a minimum of headroom regardless of the magnitude of the input signal. A method with low complexity, such that it can be performed in real time, is also desirable.

### SUMMARY

The present invention provides method of generating a quadrature amplitude modulation (QAM) signal comprising:

creating a composite amplitude modulated signal using two carriers of the same frequency wherein the two carriers are distinguished by having a phase difference of 90 degrees;

amplifying the signal in a power amplifier for transmission, the power amplifier having an input port for adjustment of a compression value of the amplifier;

repeatedly generating a signal indicative of a peak power requirement of the signal;

and using the peak power requirement to dynamically adjust the power amplifier compression to match the requirements of the instantaneous symbol power.

Preferably there is provided a time delay to ensure the power amplifier compression is adjusted when the power is required.

The time delay may be arranged such that, if the power requirement is increased, the power amplifier compression is adjusted at an advanced time before the requirement.

Otherwise the time delay may be arranged such that, if the power requirement is decreases, the power amplifier compression is adjusted at a delayed time after the requirement.

In one preferred arrangement, the signal indicative of a peak power requirement is generated by monitoring the digital symbols.

However the signal indicative of a peak power requirement may be generated by monitoring the baseband or the modulated signals.

Preferably the power amplifier compression is adjusted in steps.

However also the power amplifier compression can be adjusted gradually.

When adjusted in steps, the power amplifier compression is preferably adjusted at symbol rate. However the power amplifier compression can be adjusted at higher than symbol rate or at lower than symbol rate.

Preferably there is provided a look up table in a memory for determining the power amplifier compression from the peak power requirement.

Preferably the power amplifier compression is controlled by a digital signal.

Preferably the power amplifier compression is controlled by a digitally selecting one or more from a plurality of resistances for controlling a current supply to the power amplifier.

Alternatively the power amplifier compression may be controlled by a controlling a current supply to the power amplifier by analogue FET control.

In one example the QAM signal is a multi-channel QAM, where the symbol power is based on the sum of the individual powers.

Compression control of an RF amplifier is commonly known to be controlled by adjusting the biasing of the Amplifier. A side effect of adjusting the biasing is typically a small amount of gain change as the bias is changed. Any gain change in effect is undesired amplitude modulation. The dynamic adjustment of the compression would in effect produce a small amplitude modulated signal that would exist on the QAM signal and cause undesired distortion in the demodulated signal. In this case the compression adjustment can coincide with a amplitude pre-distortion to match the gain change caused by the bias adjustment. The pre-distortion is accomplished by a change to the DAC output value or a change in the reference voltage to the DAC. Other methods common to industry such as voltage controlled attenuators or amplifiers would also apply as method to provide the gain pre-distortion.

The other benefit of the dynamic compression adjustment of an RF amplifier is the ability to achieve higher peak powers for short intervals without destruction of the device. Destruction of an RF amplifier is limited greatly by the temperature of the device. As long as the average temperature is lower, the peak bias conditions can be exceeded beyond what is normally possible.

There may also be provided a pre-distortion compensation of the modulating signal level to correct for any small gain changes occurring with the dynamic compression adjustment.

Several objects and advantages which may be provided by the present invention or by the arrangement described herein are:

1. To provide a method of PA compression adjustment which is low complexity and able to operate in real time,

2. To provide a method of PA compression adjustment which allows the power amplifier to operate with minimal headroom regardless of the magnitude of the input signal.

3. To provide a method of PA compression adjustment which does not result in undesirable signal splatter across the frequency band,

### BRIEF DESCRIPTION OF THE DRAWINGS

FIG. 1 is a schematic block diagram of a Prior Art QAM Modulator.

FIG. 2 is a Constellation Plot for a 4-level QAM Signal.

FIG. 3 is a plot showing a Sinusoidal Voltage Waveform.

FIG. 4 is a plot of Power in the Sinusoidal Voltage of FIG. 3.

FIG. 5 a plot similar to that of FIG. 4 showing a Typical Power Amplifier Operating Point.

FIG. 6 is a schematic block diagram of a System for Adjusting Power Amplifier Compression according to the present invention.

FIG. 6A is a schematic block diagram of a System similar to that of FIG. 6 but modified to include pre-distortion of the FR signal.

FIG. 7 is a schematic block diagram of the Hardware Based Processing Unit Internals of FIG. 6.

FIG. 7A is a schematic block diagram of the Hardware Based Processing Unit Internals of FIG. 6A.

FIG. 8 is a plot showing Continuous Compression Point Adjustment.

FIG. 9 is a plot showing Discrete Compression Point Adjustment.

FIG. 10 is a constellation plot of 256 QAM limited to only a few symbols and transitions.

### DETAILED DESCRIPTION

A prior art, all digital architecture 15 for a QAM modulator 17 is shown in FIG. 1. The modulator 17 accepts a digital input 19 for input to an encoder 23. The encoder 23 divides the incoming signal into a symbol constellation corresponding to in-phase (I) (xᵣ(nT)) and quadrature (Q) (jxᵢ(nT)) phase components while also performing forward error correction (FEC) for later decoding when the signal is demodulated. The converter outputs are coupled to a QAM modulator 17 comprising identical finite impulse response (FIR) square-root raised Nyquist matched filters 25, 27. The Nyquist filters 25, 27 are a pair of identical interpolating low-pass filters which receive the I (xᵣ(nT)) and Q (jxᵢ(nT)) signals from the encoder 23 and generate real and imaginary parts of the complex band-limited base band signal. The Nyquist filters 25, 27 ameliorate intersymbol interference (ISI) which is a by-product of the amplitude modulation with limited bandwidth. After filtering, the in-phase ((yᵣ(nT′))) and quadrature (yᵢ(nT′)) components are modulated with mixers 29, 31 with the IF center frequencies 33, 35 and then summed 37 producing a band limited IF QAM output signal (g(nT)) for conversion 39 to analogue. The analogue signal is then passed through an analogue signal processing block 40, which includes an analogue reconstruction filter that removes undesired images at multiples of the sampling frequency. This block may also contain additional mixing stages and/or RF upconverter blocks suitable for translating the analogue IF signal to a different frequency. The next step is to amplify the analogue signal using a linear power amplifier (PA) 41 prior to transmitting the IF output signal 42 over the communications system. It is also possible to sum the output signals from multiple QAM modulators together and pass the resulting composite signal through the linear power amplifier. This has the advantage of reducing the number of linear power amplifiers required, as well as reducing the overall power consumption of the system.

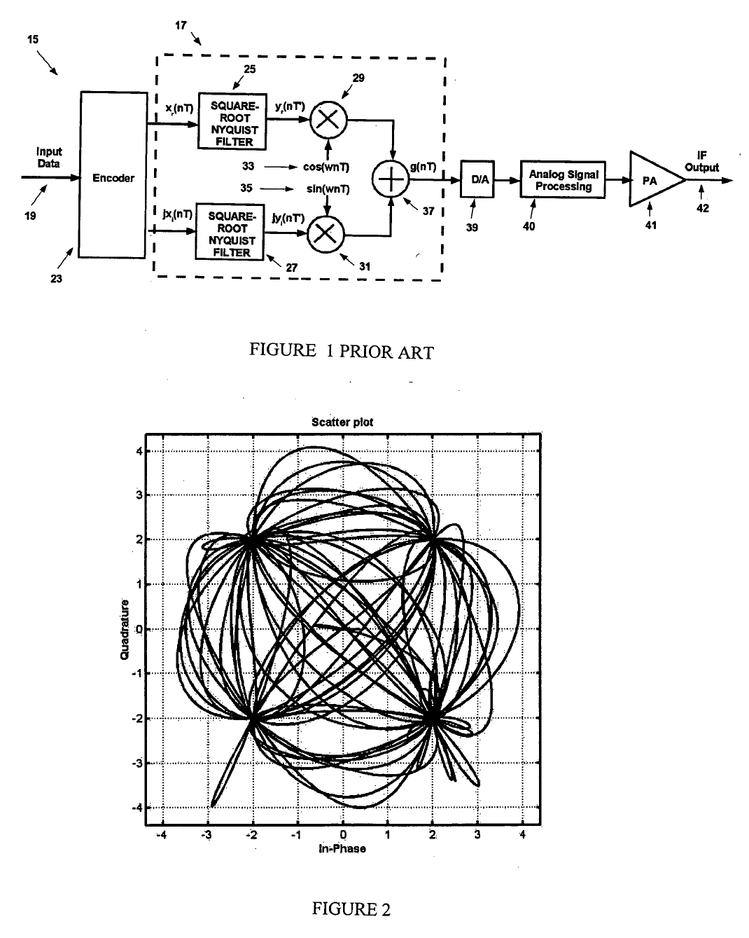

The output of a QAM modulator can be illustrated using a constellation diagram. The constellation diagram for 4-ary QAM modulation is shown in FIG. 2. The input data is represented by the 4 constellation points. The paths between the points are the result of SRRC filtering. Each path takes the same amount of time to traverse, even though their physical lengths vary. The peak power of the QAM signal occurs at the point in the constellation that is farthest from the center.

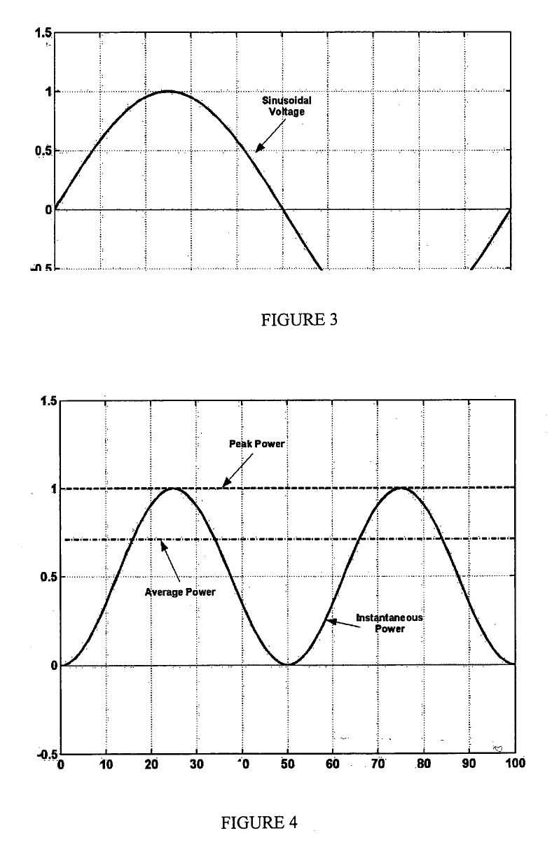

FIG. 3 illustrates a simple sinusoidal voltage waveform. The power in this sinusoidal voltage signal is proportional to the waveform shown in FIG. 4. The peak power corresponds to the maximum peak in the illustrated waveform. The average power is the root-mean-square (RMS) value of the signal, and is also illustrated.

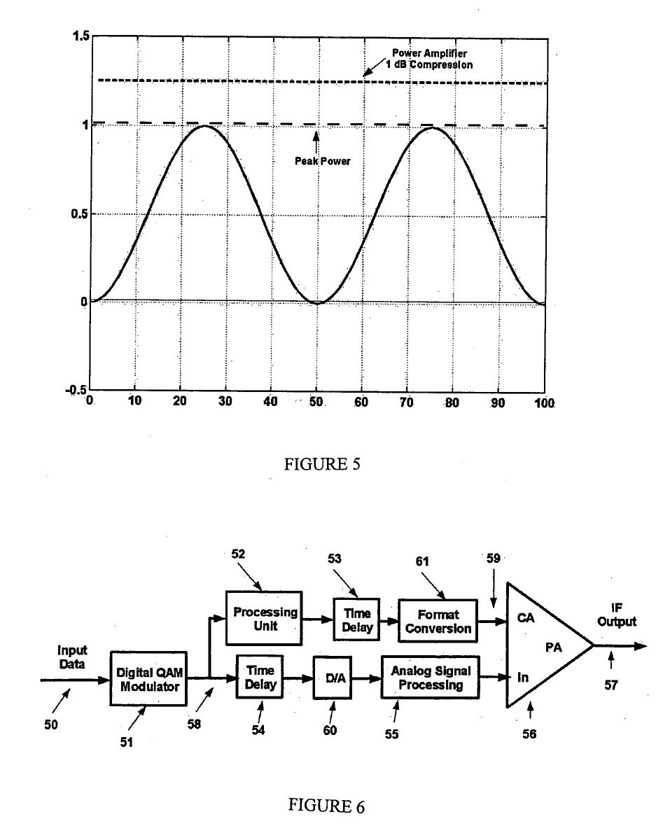

In order to amplify this signal without compression, the 1 dB compression point of the power amplifier must be set higher than the peak power in the waveform. This is illustrated in FIG. 5. It is common for the 1 dB compression to be set to a constant value.

The power consumption of the power amplifier is proportional to the compression point. The higher the compression point, the more power that is consumed. The efficiency of the power amplifier is inversely proportional to the instantaneous power in the driving signal. If the instantaneous power of the driving signal is at its peak, then the amplifier is operating efficiently. However, if the instantaneous power of the driving signal is very low, then the amplifier is operating very inefficiently since a lot of power is consumed in amplifying a small signal.

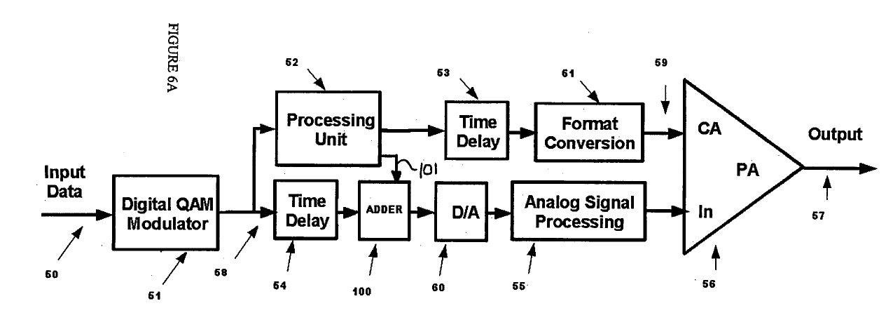

FIG. 6 illustrates the apparatus according to the present invention. The present invention adds a processing unit 52 following the Digital QAM Modulator 51, as well as a power amplifier which incorporates a compression adjustment input port 59. Such power amplifiers are commercially available and one suitable example is available from Anadigics of Warren, N.J., USA under part number ACA0861.

The processing unit takes the digital signal output from the QAM modulator as an input. It then computes the optimum compression point and passes that to the time delay element 53. There is a second time delay element 54. Each time delay element is adjusted such that the overall delay through each path is substantially identical. This ensures that the compression adjustment value reaches the power amplifier at the same time as the instantaneous power to which it applies.

The output of the time delay element 53 then passes through the format conversion block 61. The format conversion block then feeds the compression adjustment port on the power amplifier 59. In one example, the compression adjustment port 59 port on the power amplifier uses a digital signal for example by using a switched resistor network. Alternatively the port 59 can use an analogue control signal by using a voltage control resistor such as a FET. The format conversion block incorporates any circuitry necessary to convert the output of the processing unit into the required format. For example, if the compression adjust port requires an analogue signal, then the format conversion block will contain a digital to analogue converter.

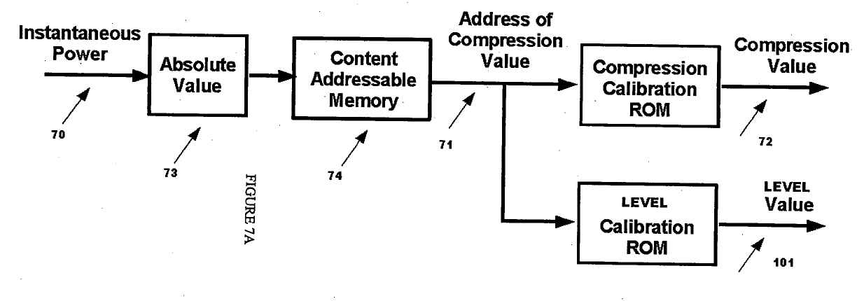

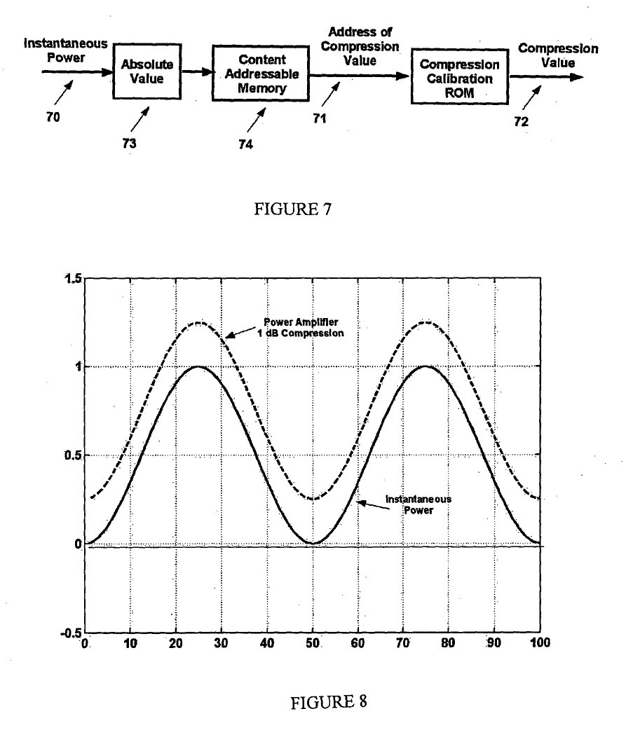

FIG. 7 illustrates the internals of the processing unit implemented in a hardware based solution for example using a FPGA (field programmable gate array) and/or discrete components.

In one example, the processing unit, when detecting the power requirement from the digital signals, takes the output from the Digital QAM modulator 70 and computes its absolute value 73. The absolute value of the digital signal output from the Digital QAM Modulator 51 is proportional to the instantaneous power. The absolute value is then used as the input to a content addressable memory (CAM) 74. The output of the CAM is the address in a look up table in the Compression Calibration Read Only Memory (ROM) which holds the compression value corresponding to that instantaneous power. This value is then output from the processing unit 72. The contents of the look up table in the Compression Calibration ROM are computed offline by various techniques including manual measurements of the amplifier characteristic and can be readily calculated by one skilled in the art depending upon the type of hardware used and its various characteristics.

Alternatively, if the number of co-efficients contained within the ROM is large, it is possible to replace the ROM with one or more n-th order polynomials which provide a (piecewise) approximation of the amplifier characteristic.

It will be apparent to anyone skilled in the art, that the processing unit could be implemented equally well using a microprocessor or other device without departing from the spirit of this invention. It should also be apparent, to anyone skilled in the art, that the Compression Calibration ROM could also be implemented as a Random Access Memory (RAM). One advantage offered by the RAM is that it allows the calibration coefficients to be updated whenever necessary to account for changing system parameters (e.g. Aging of components, temperature, etc.).

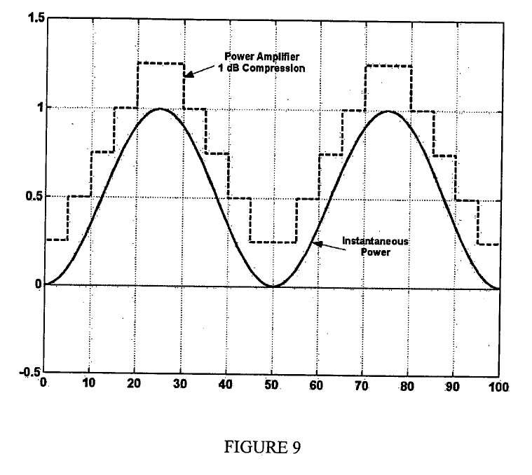

Example results from the present invention are depicted in FIG. 8 and FIG. 9 for the sinusoidal voltage signal introduced in FIGS. 3, 4, and 5. FIG. 8 shows the power amplifier compression being adjusted in continuous steps. FIG. 9 shows the power amplifier compression being adjusted in discrete steps. One advantage of discrete steps is that it could potentially reduce the number of values that must be stored in the Compression Calibration ROM.

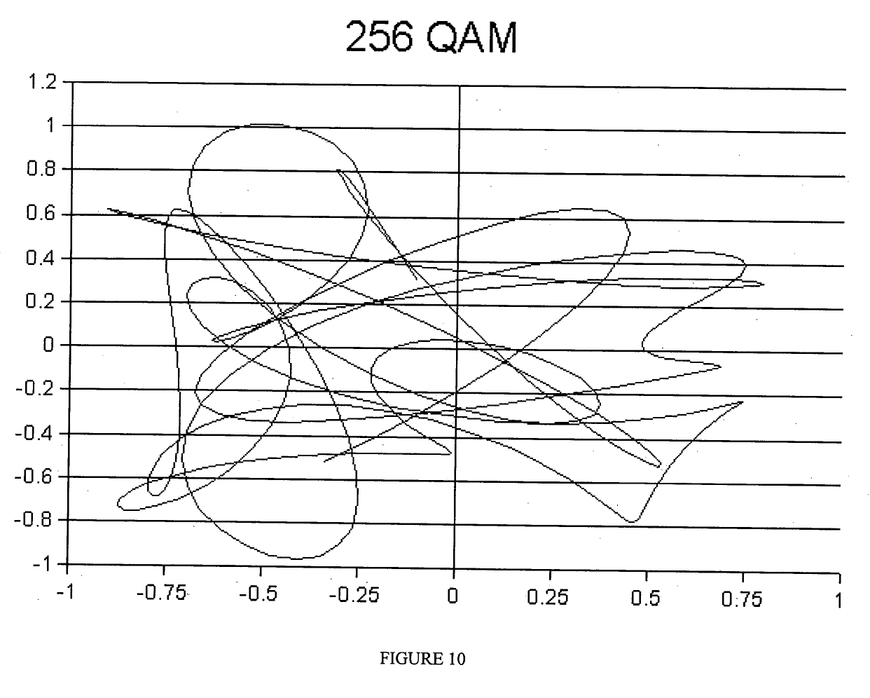

FIG. 9 shows the compression adjustment occurring multiple times within a symbol. Limits on the rate capability of the hardware compression adjustment may restrict the rate of the compression adjust. However as can be seen in FIG. 3, each symbol transition does not result in the highest peak. Efficiency in power amplifier reduction can also be achieved by a much slower rate of compression adjustment. The compression adjustment could also be done at the symbol rate and be applied over the entire symbol transition. This allows the compression adjustment to be performed less often and at a slower rate. This reduces the degree of power efficiency as a trade-off of slower adjustment. There is less impact on the power efficiency in this trade off for higher order QAM. In 256 QAM the power requirements from one transition to the next may be very low, and the power requirements for that symbol could be set ahead of time for the power amp. FIG. 10 is a constellation plot of 256 QAM limited to only a few symbols and transition. It is apparent that the power greatly varies from symbol transition to symbol transition. When a transition is going to reach the highest peak, the power amplifier can be adjusted at or above the compression it would on average be able to support.

The method of power amplifier compression adjustment also applies to optimizing power amplifier efficiency vs. the level of QAM. The amount of head room requirement for QPSK is less than higher level QAM. Hence this method of power compression adjustment can be used to compensate for the peak to average ratio requirements of each signal. This has a opposite function to that shown in U.S. Pat. No. 6,137,841 above, as the compensation is done by adjusting the compression of the power amp resulting in a power consumption savings for signals with lower peak to average ratios rather than adjusting the level of the RF signal to match the amplifier. Hence the output power transmission level is constant regardless of the QAM level, but power amplifier efficiency is improved for the lower QAM levels by compression adjustment of the amplifier. This is valid without even applying a dynamic adjustment of the compression with peak to average ratio monitoring.

As an alternative to detecting the absolute value of the output from the digital QAM modulator 70, a calculation of the power requirement for the signal can be made upon the base band, upon the modulated signal or upon the analogue RF signal. Suitable calculations by which the power requirement can be made will be apparent to one skilled in the art.

The input port of the above mentioned power amplifier provides a current adjustment pin for the amplifier and thus requires an analogue variable current to provide the adjustment of the compression. In one example described previously, this variation in the current can be provided by switching in one or more resistors selected from a plurality of such resistors to provide a required current from a fixed voltage supply. This system would therefore use a digital signal from the processing unit which is supplied through the time delay 53 to the format conversion component 61. This digital signal can be obtained from the look-up table.

In an alternative arrangement a voltage control resistor can be used of the type available commercially as an FET. In this case the digital signal can be converted to an analogue voltage which is supplied to the FET to control the current output which is then supplied to the current adjust pin of the power amplifier.

The look-up table can be of a simple form in which the adjustment is effected on a directly proportional basis. In the alternative and in a matter which is more preferred the look-up table is more complex and provides a compression for the power amplifier which is calculated, preferable empirically, by analysis of the parts concerned so as to more accurately tailor the compression to the power requirement. Such calculations are of course within the skill of one in this art.

As it is highly desirable to error on the side of providing sufficient power to match the power requirement, the timing of the adjustment of the power amplifier can be controlled so as to delay or advance the change in compression. Thus when a higher power requirement is encountered for a next time period, the adjustment of the compression can be effected in advance of the instantaneous time of arrival of the corresponding part of the waveform so as to ensure that sufficient power is available at the amplifier. Symmetrically, in the event that the power requirement decreases, a slight delay can be provided so that the corresponding decrease in power available at the amplifier is delayed slightly relative to the respective signal component to ensure that there is little or no possibility that the compression is adjusted too soon. Such changes in the delay can be effected by an algorithm controlling the time delays 53 or 54.

In many cases it may not be necessary to provide both time delays 53 and 54 and only one may be necessary controlling the time of supply of the signal component to the amplifier relative to a fixed time delay generated by the processing path providing the variation in compression for the amplifier.

In order to correct any small gain changes occurring with the dynamic compression adjustment described above, there may be provided a pre-distortion compensation of the modulating signal level.

The compression control of the RF amplifier can be used to exceed the normal average power to provide higher peak powers that would normally not be possible without damage to the RF amplifier.

The reliability of semiconductors is directly related to the temperature of the junction of the device. In MTBF analysis (mean time between failures) it is understood that for every 10 deg rise in temperature, the reliability drops in half. For example if at 30 deg a device will last 4 years, then at 40 deg it will only last 2 years. Hence the objective in semiconductor design is keep the average temperature of the junctions low to keep the device reliable enough for the application. Lets take 256 QAM as an example. Lets predict that a peak in the 256 QAM may only occur every 1 in 256 symbols (for example). The semiconductor biasing can be changed to increase the compression, but under normal conditions that would result in the junction temperature of the device becoming to high, and the reliability dropping too low. Ie they can not run the amplifier steady state in this condition. However for short intervals, like one in 256 time periods, the biasing could be increased to increase the compression. The overall effect of the increase in the junction temperature would be low because on average the temperature would increase very little. Given the fact that this invention will lower the average junction temperature, it will increase the reliability of the device. The opposite is also true. For a given amplifier device we could get more power from it without (or at least minimally) impacting the reliability! Hence the benefit of the invention is a choice between power consumption savings or increasing the power output of an amp beyond what it would normally be capable of.

The system can provide pre-distortion compensation of the modulating signal level to correct for any small gain changes occurring with the dynamic gain compression adjustment provided herein. In FIG. 6A is shown an arrangement substantially identical to that of FIG. 6 wherein there is added an adder 100. The control from the adder 100 comes from a second output from the processing unit 52. The processing unit provides a second output 101 using a concept shown in FIG. 7A, which is similar to that which is shown in FIG. 7, except there is a second ROM to provide the output 101 to the adder 100. The ROM provides the amount of value to add or subtract to correct the input value to compensate for the change in gain when the compression is changed. The time of the level change matches the time of the change compression level. The over all result is the pre-distortion causes the RF output level to be correct. An example is if a change in compression value resulting in 0.1 dB loss of gain, (as determined by characterizing the amplifier and values stored in the ROM table), then the input level is adjusted 0.1 dB higher to compensate, for the 0.1 dB loss in gain.

One feature of the invention is that power reduction is achieved for lower peak to average ratio signals (ex QPSK) vs. higher peak to average ratio signals, independent of the dynamic adjustment versus time.

Given a QPSK signal of a fixed (average) power and a QAM 256 signal of the same fixed (average) power level, the QAM signal will have a higher peak to average ratio and hence need an amplifier with a higher compression value. If the system transmits various QAM formats but is only allowed to transmit x dBm regardless of the QAM level, then the system is wasting power. It is better to switch the compression of the amplifier to a lower compression for the QPSK format as it does not have as high a peak to average ratio, and hence does not have to support the same peak power levels.

1. A method of generating a quadrature amplitude modulation (QAM) signal comprising:
creating a composite amplitude modulated signal using two carriers of the same frequency wherein the two carriers are distinguished by having a phase difference of 90 degrees;
amplifying the signal in a power amplifier for transmission, the power amplifier having an input port for adjustment of a compression value of the amplifier;
repeatedly generating a signal indicative of a peak power requirement of the signal;
and using the peak power requirement to dynamically adjust the power amplifier compression to match the requirements of the instantaneous symbol power.

2. The method according to claim 1 wherein there is provided a time delay to ensure the power amplifier compression is adjusted when the power is required.

3. The method according to claim 1 wherein the time delay is arranged such that, if the power requirement is increased, the power amplifier compression is adjusted at an advanced time before the requirement.

4. The method according to claim 1 wherein the time delay is arranged such that, if the power requirement is decreases, the power amplifier compression is adjusted at a delayed time after the requirement.

5. The method according to claim 1 wherein the signal indicative of a peak power requirement is generated by monitoring the digital symbols.

6. The method according to claim 1 wherein the signal indicative of a peak power requirement is generated by monitoring the baseband.

7. The method according to claim 1 wherein the signal indicative of a peak power requirement is generated by monitoring the modulated signals.

8. The method according to claim 1 wherein the power amplifier compression is adjusted in steps.

9. The method according to claim 1 wherein the power amplifier compression is adjusted gradually.

10. The method according to claim 1 wherein the power amplifier compression is adjusted at symbol rate

11. The method according to claim 1 wherein the power amplifier compression is adjusted at higher than symbol rate.

12. The method according to claim 1 wherein the power amplifier compression is adjusted at lower than symbol rate.

13. The method according to claim 1 wherein there is provided a look up table in a memory for determining the power amplifier compression from the peak power requirement.

14. The method according to claim 1 wherein the power amplifier compression is controlled by a digital signal.

15. The method according to claim 1 wherein the power amplifier compression is controlled by a digitally selecting one or more from a plurality of resistances for controlling a current supply to the power amplifier.

16. The method according to claim 1 wherein the power amplifier compression is controlled by a controlling a current supply to the power amplifier by analogue FET control.

17. The method according to claim 1 wherein the QAM signal is a multi-channel QAM, where the symbol power is based on the sum of the individual powers.

18. The method according to claim 1 wherein there is provided a pre-distortion compensation of the modulating signal level to correct for any small gain changes occurring with the dynamic compression adjustment.

19. The method according to claim 1 wherein the compression control of the power amplifier is used to exceed the normal average power to provide higher peak powers that would normally not be possible without damage to the RF amplifier.
